(19) United States
(12) Patent Application Publication
(10) Pub. No.: US 2009/0086988 A1
(43) Pub. Date: Apr. 2, 2009

(54) NOISE REDUCTION HEADSETS AND METHOD FOR PROVIDING THE SAME

(75) Inventors: KUEN-YING OU, Tu-Cheng (TW); TSUNG-LUNG YANG, Tu-Cheng (TW); SHENG-KAI HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXCONN TECHNOLOGY CO., LTD., Tu-Cheng (TW)

(21) Appl. No.: 11/964,768

(22) Filed: Dec. 27, 2007

(30) Foreign Application Priority Data
Sep. 28, 2007 (CN) 200710123708.6

(51) Int. Cl. G10K 11/36

(52) U.S. Cl. 381/71.6

(57) ABSTRACT

A headphone (49) of a noise-reduction headset (40) includes an ear cup (41), an external microphone (42), an internal loudspeaker (43), and a controller (33) between the external microphone and the internal loudspeaker. The external microphone receives external noise sound signals. The control unit converts the external noise sound signals into anti-phased noise sound signals which are broadcasted by the internal loudspeaker (43). The anti-phased noise sound signals interfere with and reduce the external noise sound signal entering the ear cup. The controller has a preferred related function stored therein for converting the external noise sound signals into the anti-phased noise sound signals. The preferred related function is obtained by regulating a related function in respect to a comparison between a transfer function between an external microphone (22) and an internal microphone (24) and a transfer function between an internal loudspeaker (23) and the internal microphone.

### BACKGROUND OF THE INVENTION

1. Field of the Invention

The present invention relates to noise reduction headsets and method for designing the headsets, and more particularly to an active noise reduction headset and a method for designing the headset.

2. Description of related art

Presently acoustic products such as MP3, MP4 or music mobile phones are widely used in daily life. People always wear headsets for receiving sound signals from the acoustic products. However, there are external acoustic noises which interfere with the sound signals generated by the acoustic products and received from the headsets. This reduces the sound quality received by the users of the acoustic products.

Nowadays, an active noise control (ANC) system is used in the headsets for canceling the acoustic noises. There are two kinds of active noise reduction headsets, i.e., in-ear type headsets and ear-muff type headsets.

The in-ear type headset has a compact size and is more portable as compared with the ear-muff type headset. However, the in-ear type headset merely has an external microphone for receiving sound signals. This makes adaptive control methods such as the least-mean-square (LMS) algorithm be not able to be used in the in-ear type headset, which lowers the sound quality of the in-ear type headset.

The ear-muff type headset 10 as shown in FIG. 4 includes a pair of headphones 16 each of which includes an ear cup 11, an external microphone 12, an internal loudspeaker 13 and an internal microphone 14. The external microphone 12 receives external noise signals. The external noise sound signals received by the external microphone 12 are filtered, amplified and anti-phased by an adaptive controller 15 and then sent to the internal loudspeaker 13, whereby the internal loudspeaker 13 is driven to generate primary anti-phased noise sound signals. The primary anti-phased noise sound signals interfere with the external noise sound signals so as to reduce the external noise signals in the headset 10. Meanwhile, the internal microphone 14 receives error noise sound signals between the external noise sound signals and the primary anti-phased noise sound signals and feeds the error noise sound signals to the adaptive controller 15. The error noise sound signals are filtered, amplified, and anti-phased by the adaptive controller 15 and then sent to the internal loudspeaker 13, whereby the internal loudspeaker 13 is driven to generate secondary anti-phased noise sound signals. The secondary anti-phased noise sound signals interfere with the error noise sound signals so as to reduce the error noise sound signals in the headset 10. Further, error noise sound signals are continuously sent back to the adaptive controller 15 via the internal microphone 14 to drive the internal loudspeaker 13 to generate further anti-phased noise sound signals until residual noise in the headset 10 is totally cancelled. Therefore, a comfortable and noiseless acoustic environment is obtained.

However, the ear-muff type headset 10 has two microphones, i.e. the external microphone 12 and the internal microphone 14, which respectively receive the external noise sound signals and the error noise sound signals. This makes the ear-muff type headset 10 occupy a large size and further have a higher cost. Therefore, there is a need to provide a headset 10 which has good noise reduction effect and has a compact size and low cost.

### SUMMARY OF THE INVENTION

The present invention relates, in one aspect, to a noise reduction headset which has a good noise reduction effect but occupying a compact size. The noise reduction headset includes a pair of headphones each of which includes an ear cup, an external microphone, an internal loudspeaker, and a control unit connected between the external microphone and the internal loudspeaker. The external microphone receives external noise sound signals. The control unit has a preferred related function for converting the external noise sound signals from the external microphone into an anti-phased noise sound signals. The anti-phased noise sound signals are broadcasted by the internal loudspeaker The anti-phased noise sound signals interfere with and reduce the external noise sound signals entering the ear cup.

The present invention relates, in another aspect, to a method for designing the noise reduction headset. The method includes: providing an internal microphone disposed in the ear cup of the noise reduction headset, providing a transfer function between the external microphone and the internal microphone and storing the transfer function into a first filter, providing a transfer function between the internal loudspeaker and the internal microphone and storing the transfer function into a second filter, providing a preferred related function reflecting correlations between the transfer functions and storing the preferred related function in a control unit which connected between the external microphone and the internal loudspeaker, removing the internal microphone disposed in the ear cup of the noise reduction headset, and obtaining the noise reduction headset. The step for providing the preferred related function includes:

inputting external noise sound signals respectively through the first filter and the second filter so as to obtain target signals by the first transfer function and raw signals by the second transfer function;

inputting the raw signals from the second filter into a controller so as to obtain output signals, wherein the output signals are obtained by the raw signals processed by a related function stored in the controller, the related function being obtained from adaptive control methods;

inputting the output signals from the controller and the target signals into a comparator so that the output signals from the controller are compared with the target signals in the comparator; and

regulating the related function until the comparison between the output signals and the target signals reaches a minimum value to thereby obtain the preferred related function from the related function.

Other advantages and novel features of the present invention will become more apparent from the following detailed description of preferred embodiments when taken in conjunction with the accompanying drawings, in which:

### BRIEF DESCRIPTION OF THE DRAWINGS

FIG. 1 is a schematic view showing an example of a system for obtaining transfer functions between an external microphone and an internal microphone, and between an internal loudspeaker and the internal microphone;

FIG. 2 is a block diagram showing an example for providing a preferred related function between the transfer functions obtained from the system of FIG. 1;

FIG. 3 is a schematic view showing an example of a noise reduction headset of the present invention; and

FIG. 4 is a schematic view showing a related noise reduction headset.

### DETAILED DESCRIPTION OF THE INVENTION

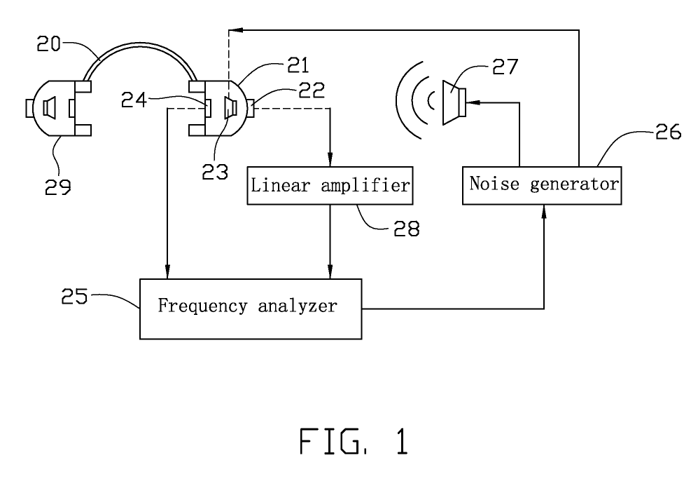

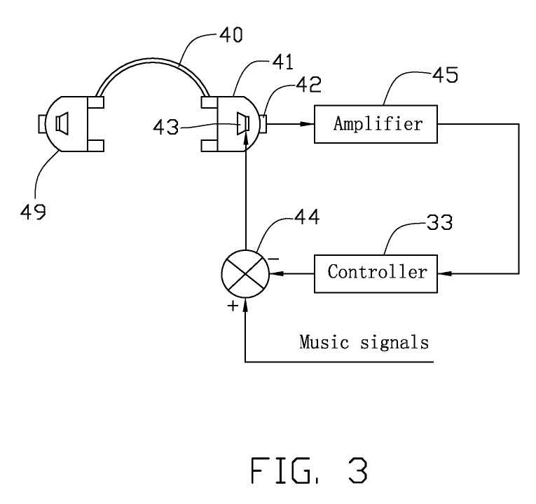

The present invention provides a noise reduction headset and a method for providing the noise reduction headset. Referring to FIG. 3, the present noise reduction headset 40 is an ear-muff type headset which includes a pair of headphones 49. Each of the headphones 49 includes an ear cup 41, an external microphone 42 and an internal loudspeaker 43. The present noise reduction headset 40 is obtained on a base of a noise reduction headset 20 shown in FIG. 1, which is subjected to a process of a method in accordance with the present invention. The noise reduction headset 20 has an internal loudspeaker 23, an internal microphone 24 and an external microphone 22. The internal loudspeaker 23 and the internal microphone 24 are disposed in an ear cup 21 of a headphone 29 of the noise reduction headset 20. The external microphone 22 is disposed outside the ear cup 21 of the noise reduction headset 20. Reference will now be made to the drawing figures to describe the method of the present invention for obtaining the headset 40 of FIG. 3 from the headset 20 of FIG. 1 in detail.

Referring to FIG. 1, a schematic view showing an example of a system for obtaining transfer functions of the noise reduction headset 20 is provided. The system includes the noise reduction headset 20, a frequency analyzer 25, and a sound source 27 such as a loudspeaker. The frequency analyzer 25 has a noise generator 26 embedded therein. The transfer functions obtained are respectively from the external microphone 22 to the internal microphone 24, and from the internal loudspeaker 23 to the internal microphone 24.

Reference will now be made to show a method for obtaining the transfer function from the external microphone 22 to the internal microphone 24 in detail. The noise generator 26 of the frequency analyzer 25 generates white noise sound signals which are sent to the sound source 27, from which the white noise sound signals are broadcasted. The white noise sound signals, in one aspect, are received by the external microphone 22. The white noise sound signals, in another aspect, transfer through the ear cup 21 and are received by the internal microphone 24. The white noise sound signals are weakened by the ear cup 21 when they transfer therethrough. The white noise sound signals received by the external and internal microphones 22, 24 are respectively sent to the frequency analyzer 25. The frequency analyzer 25 analyzes the received white noise sound signals and obtains the transfer function between the external microphone 22 and the internal microphone 24. In this embodiment, there is a linear amplifier 28 connected between the external microphone 22 and the frequency analyzer 25. The linear amplifier 28 amplifies the white noise sound signals sent from the external microphone 22 so as to facilitate the frequency analyzer 25 to receive and process the white noise sound signals from the external microphone 22. Alternatively, if the white noise sound signals from the external microphone 22 are so powerful that the frequency analyzer 25 can process them directly, there is no need to arrange the linear amplifier 28.

Reference will now be made to show a method for obtaining the transfer function from the internal loudspeaker 23 to the internal microphone 24 in detail. The noise generator 26 of the frequency analyzer 25 generates, in addition to the white noise sound signals, also pink noise sound signals. The white noise sound signals are broadcasted by the internal loudspeaker 23, during which the output characteristic curve of the internal loudspeaker 23 in the gamut can be obtained. The white noise sound signals broadcasted by the internal loudspeaker 23 is received by the internal microphone 24 in the ear cup 21 during which the response characteristic curve of the internal microphone 24 in the gamut can be obtained. The white noise sound signals received by the internal microphone 24 are transmitted to the frequency analyzer 25. The pink noise sound signals are also broadcasted by the internal loudspeaker 23, received by the internal microphone 24 and finally transmitted to the frequency analyzer 25. The frequency analyzer 25 analyzes the received white and pink noise sound signals and thereby obtains the transfer function between the internal loudspeaker 23 and the internal microphone 24.

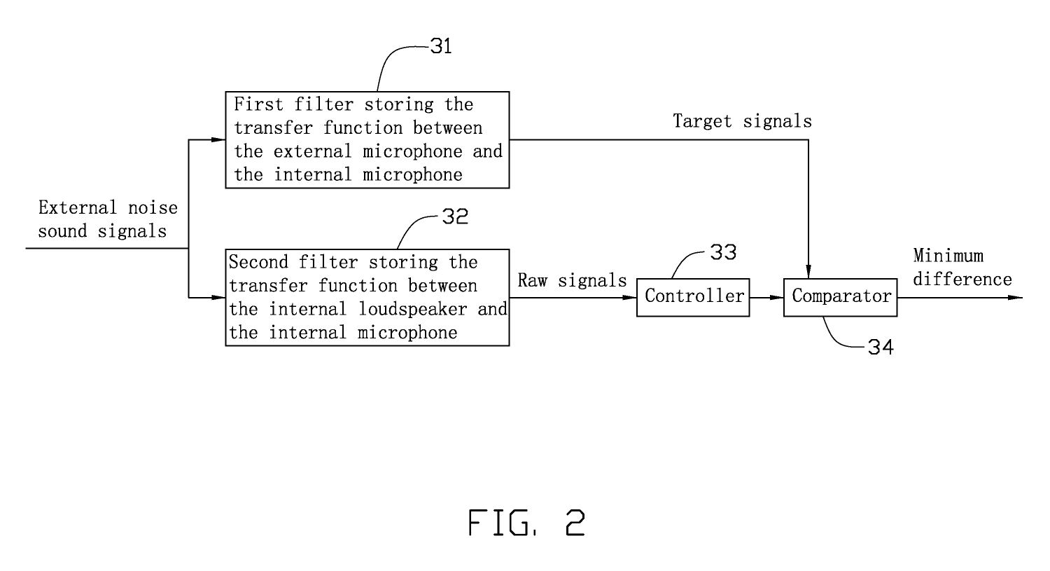

Reference will now be made to show a system for providing a preferred related function reflecting correlations between the transfer function from the external microphone 22 to the internal microphone 24 and the transfer function from the internal loudspeaker 23 to the internal microphone 24 in detail. Referring to FIG. 2, external noise sound signals are input into the system. The external noise sound signals, in one aspect, enter into a first filter 31 which stores the prior obtained transfer function between the external microphone 22 and the internal microphone 24 therein. The first filter 31 filters the input external noise sound signals and obtains output signals which act as target signals. The external noise sound signals, in another aspect, enter into a second filter 32 which stores the prior obtained transfer function between the internal loudspeaker 23 and the internal microphone 24 therein. The second filter 32 filters the input external noise sound signals and obtains output signals which act as raw signals. The raw signals enter into and are compensated by a controller 33 to obtain output signals which substantially equal to the target signals. The output signals from the controller 33 compare with the target signals in a comparator 34 and a related function registered in the controller 33 is regulated so as to keep a minimum difference between the output signals from the controller 33 and the target signals. The related function registered in the controller 33 is obtained from adaptive control methods such as the least-mean-square (LMS) algorithm. The finally regulated related function which keeps the minimum difference is the preferred related function as required. That is, the preferred related function makes the noise sound signals generated by the internal loudspeaker 23 substantially equal to the noise sound signals which come from outside and enter the ear cup 21.

Referring to FIG. 3, the related noise reduction handset 20 is simplified due to the obtained preferred related function. The simplified noise reduction handset 40 omits the internal microphones 24 of the related noise reduction handset 20. That is, each headphone 49 of the simplified noise reduction handset 40 merely includes one microphone i.e. the external microphone 42 and the internal loudspeaker 43. The controller 33 which stores the obtained preferred related function therein electrically connects the internal loudspeaker 43 with the external microphone 42. External noise sound signals, in one aspect, enter the ear cup 41 after they are weakened by the ear cup 41. The external noise signals, in another aspect, are received by the external microphone 42. The noise sound signals received by the external microphone 42 are processed and anti-phased by the controller 33, and finally, are sent to the internal loudspeaker 43 from which they are broadcasted. The anti-phased noise sound signals sent from the internal loudspeaker 43 substantially equal to the noise sound signals entering the ear cup 41. A subtractor 44 is connected between the controller 33 and the internal loudspeaker 43 for controlling the anti-phased noise sound signals from the controller 33 to enter the internal loudspeaker 43. The anti-phased noise sound signals from the controller 33 and music signals from acoustic products are sent to the internal loudspeaker 43 from which they are broadcasted in the ear cup 41. The anti-phased noise sound signals broadcasted by the internal loudspeaker 43 interfere with and thereby cancel the noise sound signals directly entering the ear cup 41, whereby the noise cancellation requirement is attained. Only the musical signals are heard in the ear cup 41. In this embodiment, there is an amplifier 45 connecting the external microphone 42 with the controller 33. The amplifier 45 amplifies the sound signals from the external microphone 42 so as to enable the controller 33 to process the sound signals from the external microphone 42 if the sound signals are too weak. Alternatively, if the sound signals from the external microphone 42 are so powerful that the controller 33 can process them directly, there is no need to arrange the amplifier 45.

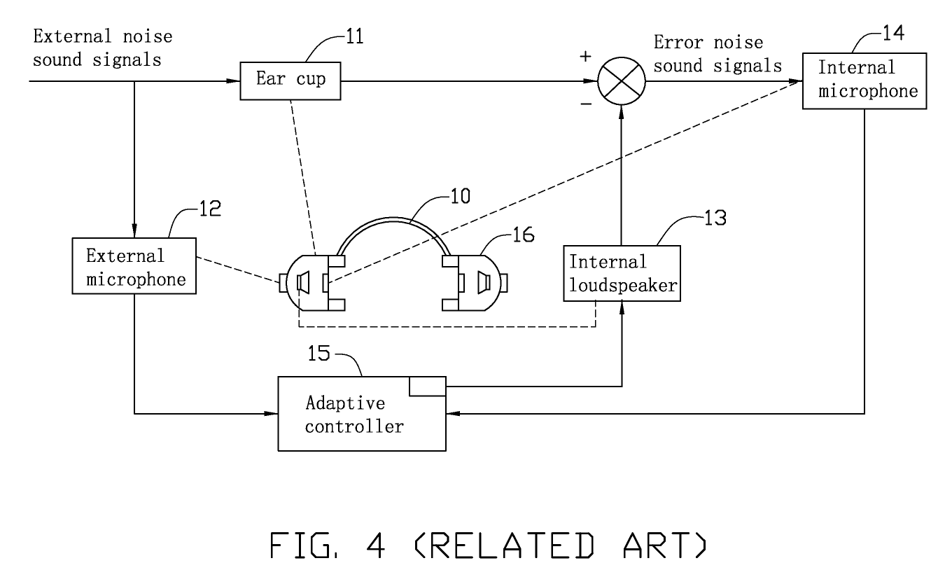

In the present noise reduction headset 40, each headphone 49 merely includes one microphone i.e. the external microphone 42. This makes the simplified noise reduction headset 40 occupy a compact size and further has a lower cost than the related noise reduction headset 10 of FIG. 4. Therefore, the simplified noise reduction headset 40 can also be an in-ear type headset. The controller 33 with the preferred related function stored therein and the subtractor 44 cooperatively form a control unit. The control unit provides the anti-phased sound signals which interfere and cancel the external noise sound signals directly entering the ear cup 41. There is no feedback circuit of FIG. 4 in the present simplified noise reduction headset 40. Therefore, the response time for the present simplified noise reduction headset 40 is shorter than the related noise reduction headset 10.

It is to be understood, how ever, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A noise reduction headset comprising:
a pair of headphones each of which comprising:
an ear cup;
an external microphone disposed on an outside of the ear cup, configured for receiving external noise sound signals;
an internal loudspeaker disposed inside the ear cup, configured for generating anti-phased noise sound signals; and
a control unit connected between the external microphone and the internal loudspeaker, the control unit receiving and processing the external noise sound signals from the external microphone to generate the anti-phased noise sound signals which are broadcasted by the internal loudspeaker, the anti-phased noise sound signals interfering with and reducing the external noise sound signals entering the ear cup;
wherein the control unit comprises a controller connected with the external microphone, the controller having a converting function stored therein, the converting function converting the external noise sound signals received by the external microphone into the anti-phased noise sound signals, the converting function being obtained by following steps:
providing a second headset having a second ear cup having a second internal loudspeaker, an internal microphone and a second external microphone;
providing a first transfer function between the second external microphone and the internal microphone and storing the first transfer function into a first filter;
providing a second transfer function between the second internal loudspeaker and the internal microphone and storing the second transfer function into a second filter;
sending second external noise sound signals into the first filter to obtain target signals by the first transfer function;
sending the second external noise sound signals into the second filter to obtain raw signals by the second transfer function, wherein the target signals and the raw signals are compared in a comparator after the raw signals flow through the controller which has a related function stored therein, the related function being obtained from adaptive control methods;
regulating the related function to obtain the converting function when the comparison reaches a minimum difference.

2. The noise reduction headset as described in claim 1, wherein the control unit has a subtractor connecting the controller with the internal loudspeaker, the subtractor controlling the anti-phased noise sound signals from the controller to enter the internal loud speaker.

3. The noise reduction headset as described in claim 2, wherein the adaptive control methods comprises a least-mean-square (LMS) algorithm.

4. The noise reduction headset as described in claim 2, further comprising an amplifier connected between the external microphone and the controller.

5. A method for providing a noise reduction headset, the noise reduction headset comprising a pair of headphones each of which comprises an ear cup, an external microphone and an internal loudspeaker, the method comprising:
providing an internal microphone disposed in the ear cup of the noise reduction headset; providing a first transfer function between the external microphone and the internal microphone and storing the first transfer function into a first filter;
providing a second transfer function between the internal loudspeaker and the internal microphone and storing the second transfer function into a second filter;
providing a preferred related function reflecting correlations between the first and second transfer functions and storing the preferred related function in a control unit which is connected between the external microphone and the internal loudspeaker; and
removing the internal microphone disposed in the ear cup of the noise reduction headset to obtain the noise reduction headset; wherein
the step for providing the preferred related function comprises:
inputting external noise sound signals respectively through the first filter and the second filter so as to obtain target signals by the first transfer function and raw signals by the second transfer function;
inputting the raw signals from the second filter into a controller so as to obtain output signals, wherein the output signals are obtained by the raw signals processed by a related function stored in the controller, the related function being obtained adaptive control methods;
inputting the output signals from the controller and the target signals into a comparator so that the output signals from the controller are compared with the target signals in the comparator; and
regulating the related function until the comparison between the output signals and the target signals reaches a minimum value to thereby obtain the preferred related function from the related function.

6. The method as described in claim 5, wherein an amplifier is connected between the external microphone and the control unit for amplifying noise sound signals from the external microphone to be fed into the control unit.

7. The method as described in claim 5, wherein the control unit comprises a controller connected with the external microphone and a subtractor connecting the controller with the internal loudspeaker, the controller storing the preferred related function therein, the subtractor controlling anti-phased noise sound signals to be broadcasted by the internal loudspeaker, wherein the anti-phasing noise sound signals are obtained by the noise sound signals transferred the external microphone and processed by the preferred related function stored in the controller.

8. The method as described in claim 5, wherein the step of providing the first transfer function between an internal microphone and an external microphone comprises:
inputting white noise sound signals into the internal microphone through the ear cup and into the external microphone;
sending the white noise sound signals from the internal microphone and the external microphone into a frequency analyzer;
analyzing the white noise sounds signals from the internal microphone and the external microphone in the frequency analyzer; and
obtaining the first transfer function between the internal microphone and the external microphone.

9. The method as described in claim 8, wherein the step of providing a second transfer function between the internal loudspeaker and the internal microphone comprises:
inputting the white noise sound signals into the internal loudspeaker to make the internal loudspeaker generate the white noise sound signals which are received by the internal microphone;
sending the white noise sound signals from the internal microphone to the frequency analyzer;
inputting pink noise sound signals into the internal loudspeaker to make the internal loudspeaker generate the pink noise sound signals which are received by the internal microphone;
sending the pick noise sound signals from the internal microphone to the frequency analyzer;
analyzing the white noise sounds signals from the internal microphone and the pink noise sound signals from the internal microphone in the frequency analyzer; and
obtaining the second transfer function between the internal loudspeaker and the internal microphone.

10. The method as described in claim 9, wherein an amplifier is connected between the external microphone and the frequency analyzer for amplifying the white noise sound signals from the external microphone to the frequency analyzer.
